(19) United States
(12) Patent Application Publication
(10) Pub. No.: US 2006/0087171 A1
(43) Pub. Date: Apr. 27, 2006

(54) Spinning rims for a bicycle

(76) Inventors: Dwayne Riley, Woodhaven, NY (US); Larry Hall, Woodside Queens, NY (US); McAyo Parrot, Queens, NY (US)

Correspondence Address: LITMAN LAW OFFICES, LTD, PO BOX 15035, CRYSTAL CITY STATION, ARLINGTON, VA, 22215, US

(21) Appl. No.: 11/228,402

(22) Filed: Sep. 19, 2005

Related U.S. Application Data
(60) Provisional application No. 60/620,281, filed on Oct. 21, 2004.

(51) Int. Cl. B60B 7/06

(52) U.S. Cl. 301/37.25; 301/37.41

(57) ABSTRACT

The spinning rims for a bicycle include a spinning rim assembly having a wheel with a wheel hub, a first connecting member operatively connected to the wheel hub by a bearing assembly. The bearing assembly configured to provide independent rotational motion between the first connecting member and the wheel hub. A spinning rim is centrally disposed within the wheel and extends generally outwardly from the first connecting member, wherein the bearing assembly allows the spinning rim to rotate independently of the wheel when a bicycle is in motion and when the bicycle comes to a stop the spinning rims may continue to freely rotate by inertia.

### CROSS-REFERENCE TO RELATED APPLICATION

This application claims the benefit of U.S. Provisional Patent Application Ser. No. 60/620,281, filed Oct. 21, 2004.

### BACKGROUND OF THE INVENTION

1. Field of the Invention

The present invention relates to bicycle wheel accessories. More particularly, the invention pertains to a wheel ornamentation that is mounted for rotation with respect to the wheel.

2. Description of the Related Art

The bicycle industry has developed into a competitive market where consumers' preferences drive the market place. Consumers are generally searching for creative and innovative products and accessories that differentiate their bicycle from other bicycles. Moreover, bicycle enthusiasts enjoy adding accessories to their bicycles that enhance the appearance of the bicycle. One way to enhance the appearance of the bicycle is to purchase custom wheels. Another way to enhance the appearance of the bicycle is to attach spinner ornamentations that enhance the appearance of the wheel.

### SUMMARY OF THE INVENTION

The spinning rims for a bicycle include a spinning rim assembly having a wheel with a wheel hub, a first connecting member operatively connected to the wheel hub by a bearing assembly. The bearing assembly is configured to provide independent rotational motion between the first connecting member and the wheel hub. A spinning rim is centrally disposed within the wheel and extends generally outwardly from the first connecting member.

The spinning rims can be incorporated as part of the bicycle wheel or can be mounted to the bicycle wheel as an accessory. The spinning rims are arranged and constructed to rotate freely about a central axis defined by the axis of spindle, which extends through the bicycle wheel hub. The spinning rim assembly is positioned on the bicycle wheels such that the spinning rims can rotate in either the same direction as the bicycle wheels or the opposite direction of the bicycle wheels.

In addition, the spinning rims are disposed on the bicycle wheels such that the spinning rims rotate independently of the bicycle wheels. As the bicycle accelerates or moves with a forward velocity, the spinning rims are carried by the rotation of the bicycle wheels and rotate as well. As the bicycle decelerates or stops, the rotation of the bicycle wheels decelerate, but the spinning rims continue to freely rotate by inertia. Furthermore, the spinning rims are configured to rotate at different rotational speed as compared to the bicycle wheel rotational speed.

Accordingly, the invention provides improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of spinning rims for a bicycle according to the present invention.

FIG. 2A is a front elevational view of spinning rims for a bicycle according to the present invention.

FIG. 2B is a cross-sectional side view of spinning rims for a bicycle according to the present invention taken along line 2B-2B of FIG. 2A.

FIG. 3A is a front elevational view of spinning rims for a bicycle according to the present invention.

FIG. 3B is a cross-sectional side view of spinning rims for a bicycle according to the present invention taken along line 3B-3B of FIG. 3A.

FIG. 4A is a front elevational view of spinning rims for a bicycle according to the present invention showing a spoke bicycle wheel constructed with the spinning rims.

FIG. 4B is a front elevational view of spinning rims for a bicycle according to the present invention showing a mag bicycle wheel constructed with the spinning rims.

FIG. 4C is a cross-sectional side view of spinning rims for a bicycle according to the present invention taken along line 4C-4C of FIGS. 4A-4B.

FIG. 5 is a front elevational view of spinning rims for a bicycle according to the present invention showing a light attached thereon.

Similar reference characters denote corresponding features consistently throughout the attached drawings.

### DETAILED DESCRIPTION OF THE PREFERRED EMBODIMENTS

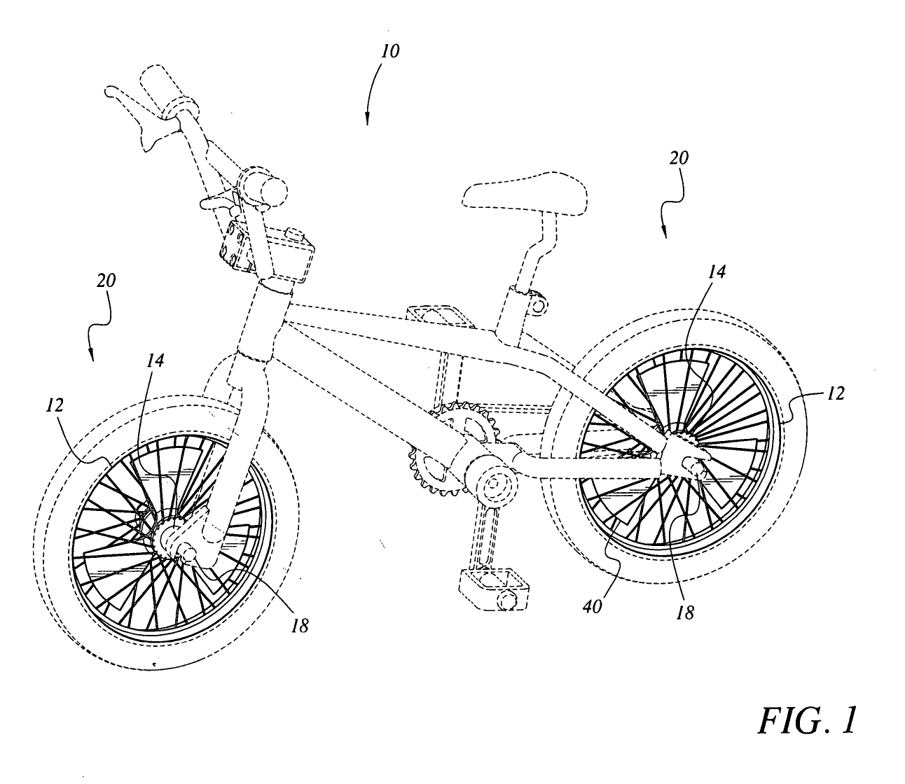

FIGS. 1-5 illustrate a spinning rim assembly 20 having a spinning rim 40 rotably connected to a bicycle wheel 1 2 according to the present invention. As shown in FIG. 1, the spinning rims 40 are configured and designed for use with a bicycle 10. The spinning rim 40 can be incorporated as part of the bicycle wheel 12 or can be mounted to the bicycle wheel 12 as an accessory. The spinning rims 40 are arranged and constructed to rotate freely about a central axis defined by the axis of spindle 18, which extends through the bicycle wheel hub 14. The spinning rim assembly 20 is positioned on the bicycle wheels 12 such that the spinning rims 40 can rotate in either the same direction as the bicycle wheels 12 or the opposite direction of the bicycle wheels 12.

Additionally, the spinning rims 40 are positioned on the bicycle wheels 12 such that the spinning rims 40 rotate independently of the bicycle wheels 12. Hence, when the bicycle 10 accelerates or moves with a forward velocity, the spinning rims 40 are carried by the rotation of the bicycle wheels 12 and rotate as well. As the bicycle 10 decelerates or stops the rotation of the bicycle wheels 12 decelerate too. However, the spinning rims 40 may continue to freely rotate by inertia.

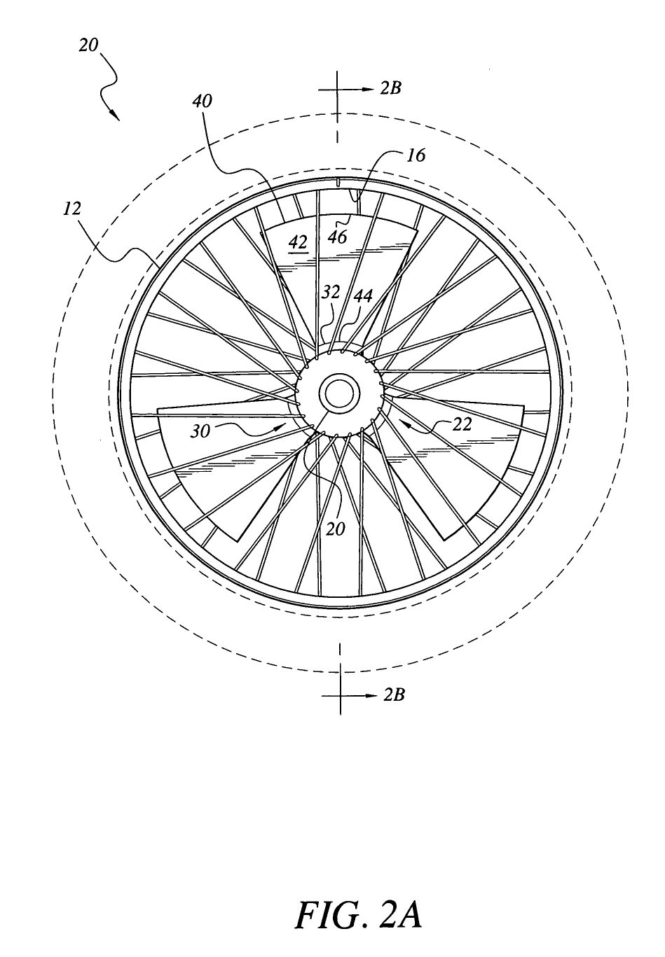

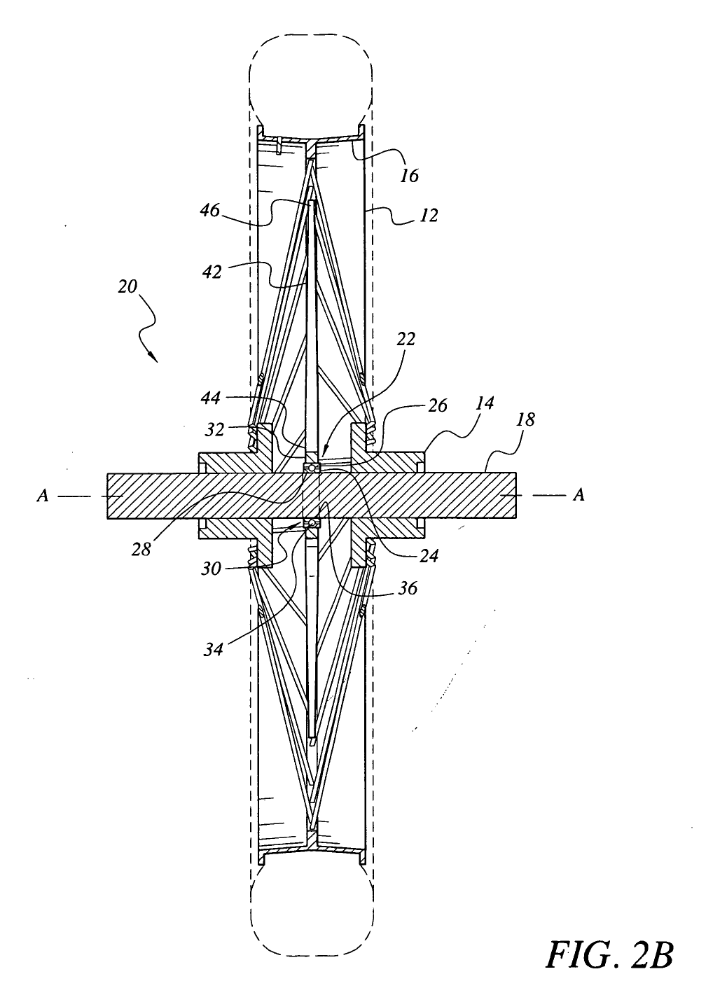

As shown in FIGS. 2A-2B, the spinning rim assembly 20 comprises a spinning rim 40 centrally disposed within a bicycle wheel 12, such as a spoke or mag bicycle wheel. The spinning rim assembly 20 includes a first connecting member, adapter, arm, or mounting bracket, 22 connected to the spinning rim 40 for free rotation thereof. The first connecting member 22 is designed and configured to operatively connect with any bicycle wheel hub 14. Typically, the first connecting member 22 is press fitted on the bicycle wheel hub 14, which is mounted to the bicycle spindle, axle or supporting shaft 18. However, the first connecting member 22 may be connected to the bicycle wheel hub 14 by other suitable connecting means or methods, such as welding, fastening, brazing, or soldering.

Alternatively, the first connecting member 22 may include at least two relatively symmetrical or non-symmetrical parts, pieces, or halves, that are connected, joined, or attached to each other to form and define the first connecting member 22. In this arrangement, the two-halves of the first connecting member 22 are designed and configured to mount around the bicycle wheel hub 14 for rotation thereof. Any suitable connecting means may be employed to connect the two-halves of the first connecting member 22 together. For example, a fastener, such as threaded bolts and nuts, screws, clamps, pins, or rivets, may be used to secure the two-halves of the first connecting member 22 around the bicycle wheel hub 14.

The first connecting member 22 has an inner wall 24, an outer wall 26, and a central aperture, hole, or substantially cylindrical bore 28 extending through the first connecting member 22. The inner wall 24 defines the central aperture 28. The central aperture 28 is configured to align with the axis A when the first connecting member 22 is connected, mounted, or attached to the bicycle wheel hub 14. The first connecting member 22 includes a bearing assembly 30, which operatively connects the first connecting member 22 to the bicycle wheel hub 14.

The first connecting member 22 may include a connecting arm 32, such as a flange, collar, or coupling, which extends from the bearing assembly 30. The connecting arm 32 is configured for connecting different types of spinning blades 42 thereon. The spinning blades 42 may be connected to the connecting arm 32 by means of a fastener. The fastener may be a screw, bolt, nut, rivet, pin, key, clamp, or other suitable fastening means. Alternatively, the spinning blades 42 may be connected to the connecting arm 32 by means of welding, brazing, or soldering.

It will be appreciated that different types of bearing assemblies may be utilized to provide a desired degree of rotational motion between the spinning rims 40 and the bicycle wheel hub 14. For example, the bearing assembly 30 may be a wheel bearing hub, flanged mounted bearing, a ball bearing, sealed cartridge bearing, thrust bearing, double row wall ball bearing, deep grove ball bearing, miniature bearing, taper roller bearing, needle bearing, self-aligning bearing, pilot bearing, a clutch bearing or any other suitable bearing assembly, which allows the spinning rim 40 to rotate at a different speed relative to the bicycle wheel 12.

By way of example, the first connecting member 22 may define the bearing assembly 30, wherein the inner wall 24 defines an inner bearing race, the outer wall 26 defines outer bearing race, and the central aperture 28 defines a generally cylindrical hole extending through the inner bearing race. The inner bearing race 24 being positioned inside the outer bearing race 26 with a plurality of ball bearings 34 located in a bearing recess 36. The ball bearings 34 being positioned between the outer bearing race 26 and the inner bearing race 24. A bearing collar may be provided to provide radial support to the inner bearing race. If needed, at least on retaining ring may be provided to provide axial support to the bearing assembly 30.

The spinning rim 40 includes spinning blades 42 having an inner portion 44 connected to first connecting member 22 and an outer portion 46, which is located approximately adjacent to the inner portion 16 of the bicycle wheel 12. The spinning blades 42 radially extend outwardly from the outer circumference the first connecting member 22 in a generally perpendicular orientation with respect to central axis A of the bicycle wheel hub 14. The spinning blades 42 may be connected to the outer wall 26 of the first connecting member 22 or may be removably connected to the outer wall 26 by means of the connecting arm 32.

For example, when the connecting arm 32 is employed as a flange, the flange includes a plurality of holes adapted for alignment with a plurality of holes disposed on the spinning blades 42. A plurality of fasteners connects and securely holds the spinning blades 42 to the flange. The fasteners may be bolts, nuts, screws, rivets, clamps, or other suitable fastening means. The holes disposed on the flange may be internally threaded for engaging the fasteners. Alternatively, a collar and sleeve connection may be used, wherein the collar and sleeve are configured to slidably engage and securely hold the spinning blades 42 to the first connecting member 22. Additionally, other suitable connecting means, such as a bracket, clip, linkage arm, dowel, pin, key, or may be used to removably connect the spinning rim 40 to the first connecting member 22. As can be appreciated, the removing of the spinning blades 42 permit a variety of designs or styles to be employed as part of the spinning rim 40.

The spinning blades 42 may be of any shape and size and is not limited to the configuration illustrated in the drawings. Additionally, more than one first connecting member 22 may be disposed on a single bicycle wheel hub 14. When more than one first connecting member 22 is connected to the bicycle wheel hub 14, each first connecting member 22 comprises a different sized and/or shaped spinning rim 40 that extends generally outward in a relatively tangential direction with respect to the bicycle wheel hub 14. Each spinning rim 40 configured to have different rotational velocities with respect to each other. For example, one spinning rim 40 may be configured so that the majority of the mass of the spinning blade 42 is mainly located or distributed about the outer portion 46 so as to increase the angular moment of inertia relative to another spinning rim 40, which has the majority of the mass of the spinning blade 42 located or distributed about the inner portion 44. The spinning rims 40 are constructed and arranged such that rotation of the spinning blades 42 will not interfere with the spokes of the bicycle wheel 12.

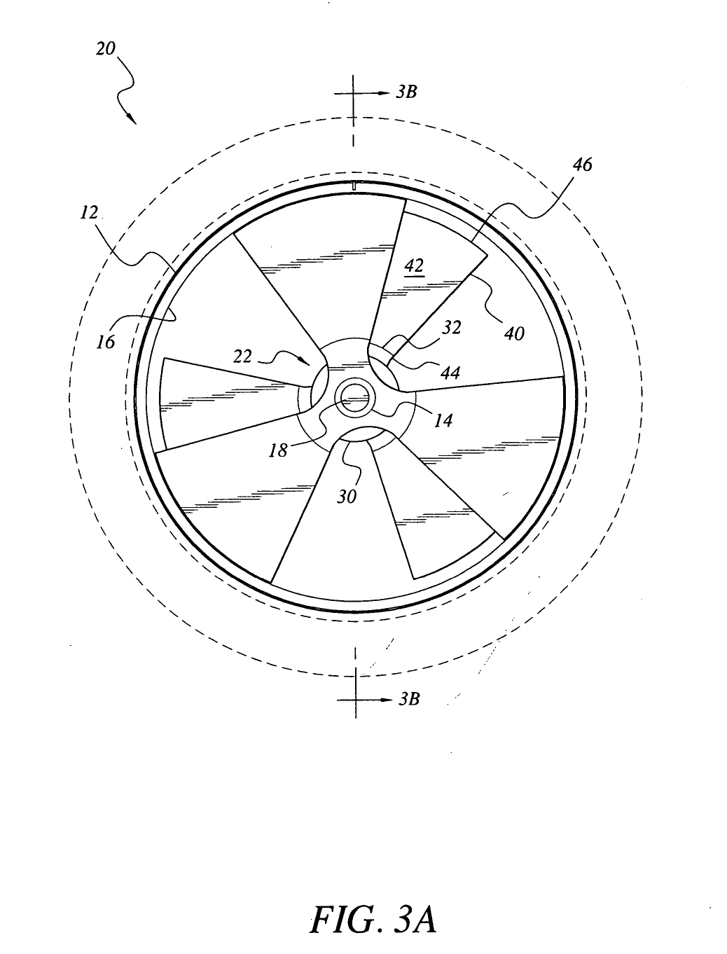

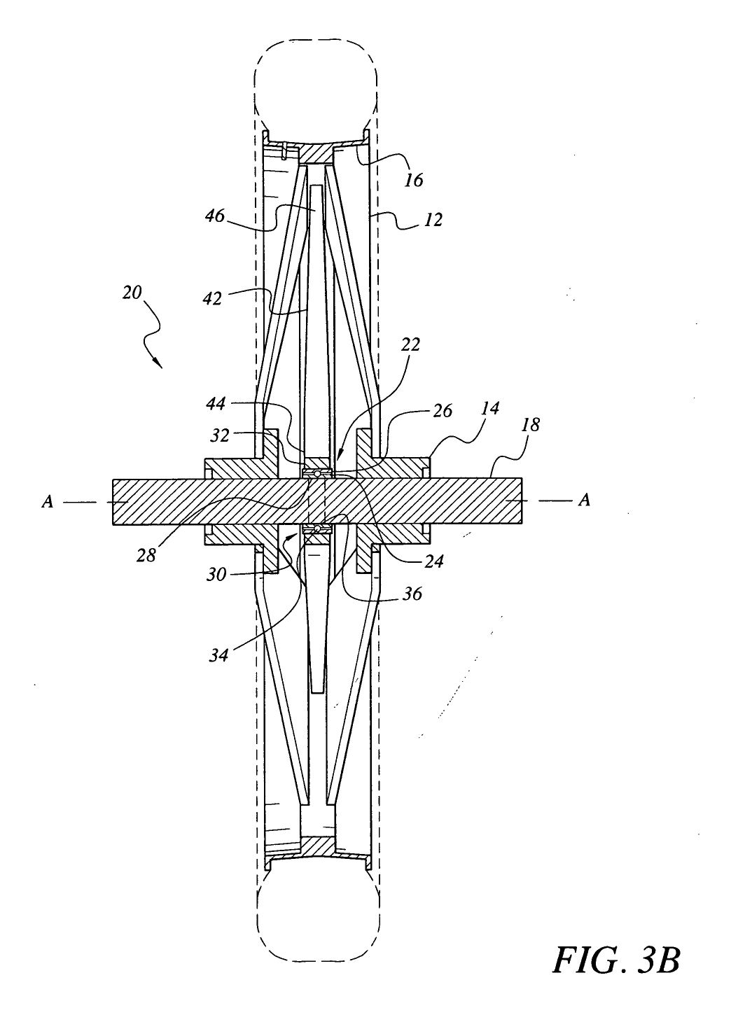

FIGS. 3A-3B illustrate another embodiment of the present invention, which is substantially similar to the first embodiment, as described above. This embodiment utilizes the bicycle wheel 12 as part of the spinning rim assembly 20. The spinning rim assembly 20 comprises a spinning rim 40, a bicycle wheel 12, and a first connecting member 22. The bicycle wheel 12 may be any type of bicycle wheel, such as a spoke wheel or a mag wheel. The mag bicycle wheel 12 is configured to incorporate the first connecting member 22 as part of the bicycle wheel hub 14, wherein the first connecting member 22 defines a bearing assembly 30 supportively connected to the bicycle wheel hub 14. The bearing assembly 30 includes an inner bearing race 24 positioned inside an outer bearing race 26 with a plurality of ball bearings 34 being positioned between the outer bearing race 26 and the inner bearing race 24. The ball bearings 34 are located in a bearing recess 36.

Alternatively, the bearing assembly 30 may be a wheel bearing hub, flanged mounted bearing, a ball bearing, sealed cartridge bearing, thrust bearing, double row wall ball bearing, deep grove ball bearing, miniature bearing, taper roller bearing, needle bearing, self-aligning bearing, pilot bearing, a clutch bearing or any other suitable bearing assembly, which allows the spinning rim 40 to rotate at a different speed relative to the bicycle wheel 12. As can be appreciated the bearing assemblies may be utilized to provide a desired degree of rotational motion between the spinning rims 40 and the bicycle wheel hub 14.

The spinning rim 40 includes spinning blades 42 having an inner portion 44 connected to first connecting member 22 and an outer portion 46, which is located approximately adjacent to the inner portion 16 of the bicycle wheel 12. The spinning blades 42 radially extend outwardly from the outer circumference of the first connecting member 22 in a generally perpendicular orientation with respect to central axis A of the bicycle wheel hub 14. The spinning blades 42 may be connected to the outer wall 26 of the first connecting member 22 or may be removably connected to the outer wall 26 by means of the connecting arm 32, as describe above.

The mag bicycle wheel 12 and spinning rim 40 are configured so that the spinning rim 40 rotates at a different rotational speed than the speed of the mag bicycle wheel 12. Additionally, the spinning rim 40 continues to rotate after the mag bicycle wheel 12 has stopped spinning. As described above, more than one spinning rim 40 may be connected to the bicycle wheel hub 14. For example, two bearing assemblies 30 may be disposed adjacent to each other on the bicycle wheel hub 14 with one bearing assembly 30 being configured to rotate at a different speed than the other bearing assembly 30. Moreover, different shapes and sizes of spinning blades 42 may extend from each of the bearing assemblies 30.

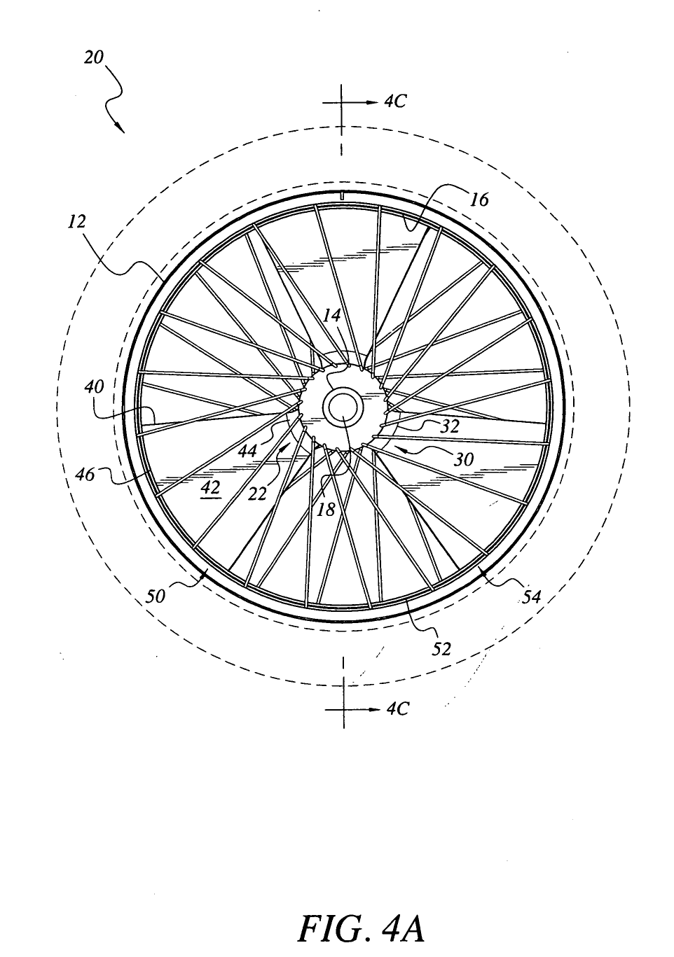

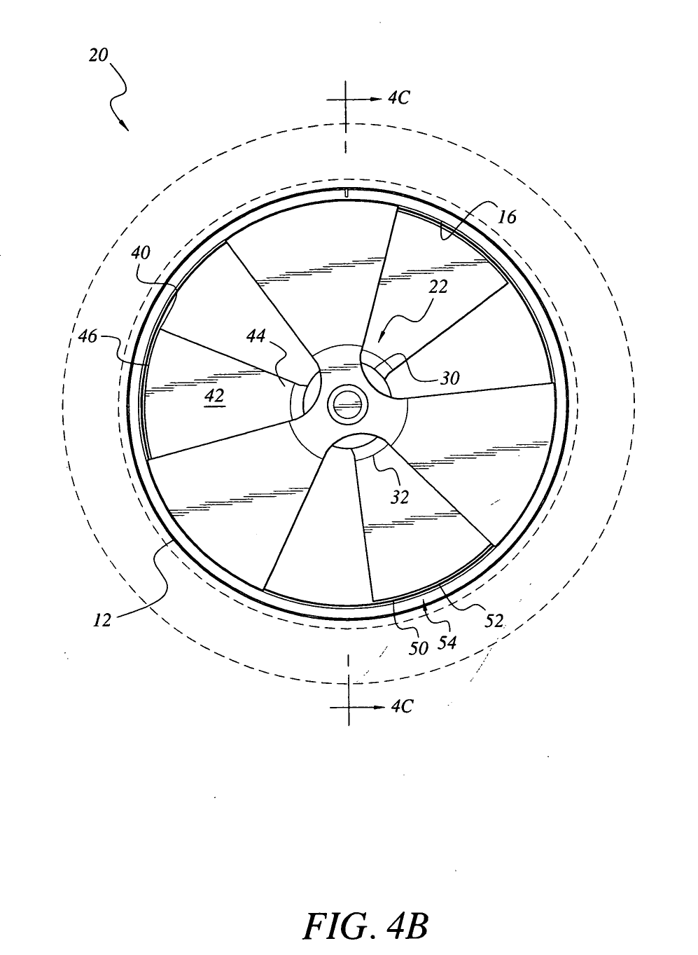

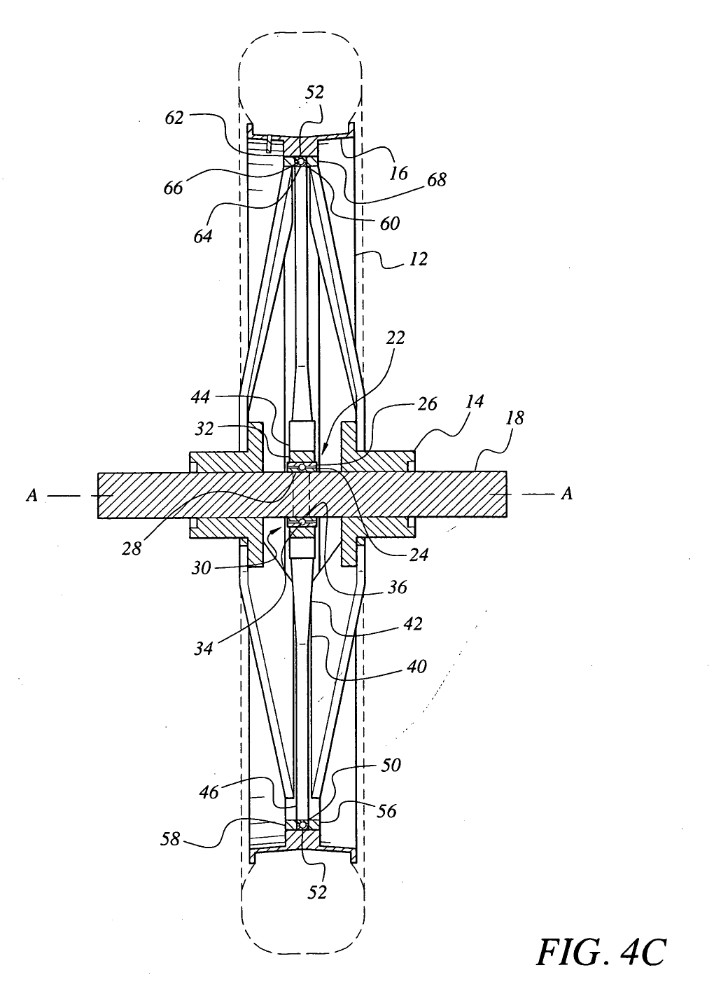

With respect to FIGS. 4A-4C, an embodiment is illustrated where the spinning rim assembly 20 is a bicycle wheel 12 configured to incorporate the spinning rim 40 as part of the construction of bicycle wheel 12. As depicted in FIGS. 4A and 4B, the bicycle wheel 12 may be either a spoke wheel or a mag wheel having a spinning rim, a first connecting member 22, and a second connecting member 50. The bicycle wheel 12 is configured to incorporate the first and second connecting members 22 and 50, respectively, as part of the bicycle wheel 12.

The first connecting member 22 is operatively connected to the bicycle wheel hub 14. The first connecting member 22 is preferably press fitted on the bicycle wheel hub 14. However, as described above, the first connecting member 22 may be connected to the bicycle wheel hub 14 by other suitable connecting means. Additionally, the first connecting member 22, as described above, may be constructed from two-halves, which form the first connecting member 22. The two-halves are designed and configured to mount around the bicycle wheel hub 14 for rotation thereof. A fastener is used to secure the two-halves of the first connecting member 22 around the bicycle wheel hub 14.

The first connecting member 22, as described above, has an inner wall 24, outer wall 26, and a central aperture, hole or substantially cylindrical bore 28, which is defined by the inner wall 24. The central aperture 28 is configured to align with the axis A of spindle 18 when the first connecting member 22 is connected to the bicycle wheel hub 14. The first connecting member 22 includes a bearing assembly 30, which operatively connects the first connecting member 22 to the bicycle wheel hub 14. As describe above, other types of bearing assemblies may be used to provide a desired degree of rotational motion between the spinning rim 40 and the bicycle wheel 12.

The spinning rim 40 includes spinning blades 42 having an inner portion 44 connected to first connecting member 22 and an outer portion 46. The outer portion 46 of the spinning blades 42 extends adjacent to the inner portion 16 of the bicycle wheel 12. The spinning blades 42 radially extend outwardly from the outer circumference the first connecting member 22 in a generally perpendicular orientation with respect to central axis A of spindle 18 of the bicycle wheel hub 14. The spinning blades 42 may be connected to the outer wall 26 of the first connecting member 22 or may be removably connected to the outer wall 26 by means of the connecting arm 32, as describe above.

The second connecting member 50 is operatively connected to the outer portion 46 of the spinning blade 42 by bearing assembly 60. A channel, passageway, recess, track, groove, slot, sleeve, or saddle 52 is disposed in the inner portion 16 of the bicycle wheel 12. The track 52 extends circumferentially along the inner portion 16 of the bicycle wheel 12 to define a generally U-shaped track having opposing edge portions 56 and 58 for the bearing assembly 60 to travel within. Alternatively, track 52 may include two opposing arms or legs, which extend from the end portions of the U-shaped track 52 to define a generally C-shape track. The bearing assembly 60 is connected to the second connecting member 50 and fits within the track 52 to facilitate rotation of the spinning blades 42. Any suitable connection means, such as fastening, welding, brazing, or soldering, may be employ to secure the bearing assembly 60 to the second connecting member 50. The bearing assembly 60 includes an inner bearing race 62 positioned inside an outer bearing race 64 with a plurality of ball bearings 66 being positioned between the outer bearing race 64 and the inner bearing race 62. The ball bearings 66 are located in a bearing recess 68.

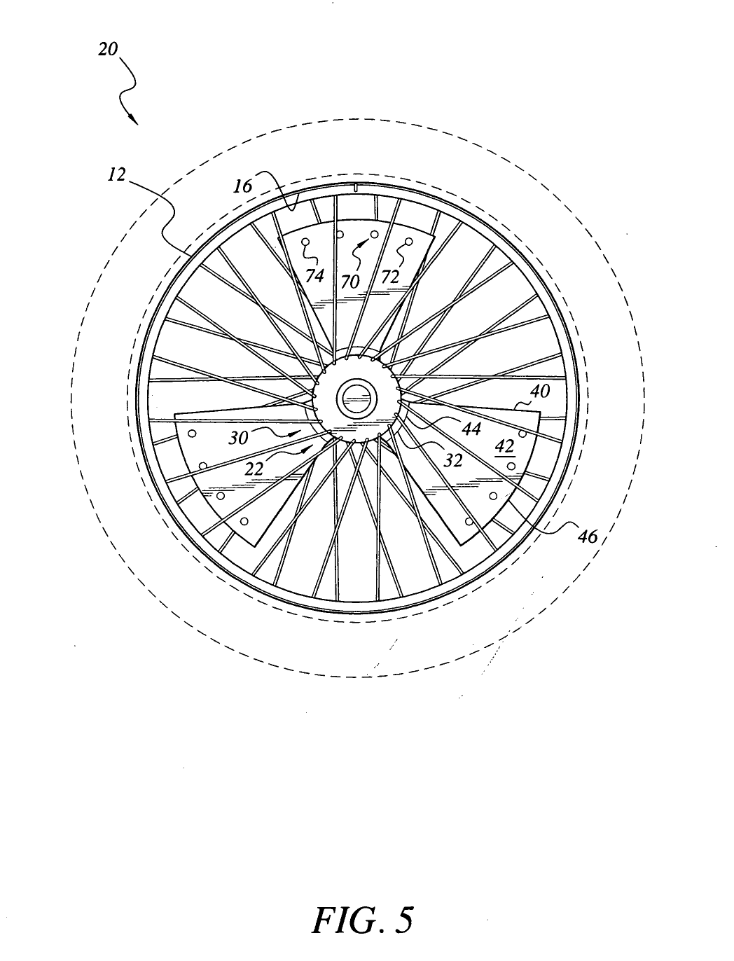

In FIG. 5, the spinning rim assembly 20 includes an illuminating, light emitting, or reflecting device 70. The illuminating device 70 includes a plurality of lights 72, which are energized by a power source. Preferably, each light 72 includes a battery disposed within the light housing 74 for providing power to the light 72. The lights 72 may display an array of different colors. The lights 72 may comprise of liquid crystal display (“LCD”) or light emitting diodes (“LED”). The lights 72 are connected to the outer portion 46 of the spinning blades 42 for illumination thereof. Alternatively, a plurality of reflectors may be disposed on the spinning rims 40 for providing better visibility to on-coming traffic.

The spinning rims 40 may be made from any suitable material, for example, metal, aluminum, plastic, carbon fiber, ceramic, fiber glass, or polymeric materials. Preferably, the spinning rims 40 are made from a metal and/or alloy having generally corrosive resistant, relatively light weight, and high strength properties. The outer portion 46 or the entire portion of the spinning blades 42 may be chrome plated.

It is to be understood that the present invention is not limited to the embodiments described above, but encompasses any and all embodiments within the scope of the following claims.

We claim:

1. A spinning rim bicycle wheel assembly, comprising:
a wheel having a wheel hub;
a first connecting member having a first bearing assembly operatively connected to said wheel hub, said first bearing assembly configured to provide independent rotational motion between said first connecting member and said wheel hub; and,
a first spinning rim centrally disposed within said wheel, said first spinning rim extending outwardly from said first connecting member;
wherein said bearing assembly allows said first spinning rim to rotate independently relative to the rotation of said wheel.

2. The spinning rim bicycle wheel assembly according to claim 1, wherein said first spinning rim includes spinning blades having an inner portion connected to said first connecting member and an outer portion extending radially outwardly from an outer circumference of said first connecting member.

3. The spinning rim bicycle wheel assembly according to claim 1, wherein said first spinning rim is removeably connected to said first connecting member.

4. The spinning rim bicycle wheel assembly according to claim 1, further comprising:
a second connecting member having a second bearing assembly operatively connected to said wheel hub adjacent said first connecting member, said second bearing assembly configured to provide independent rotational motion between said second connecting member and said wheel hub; and
a second spinning rim centrally disposed within said wheel and adjacent to said first spinning rim, said second spinning rim extending outwardly from said second connecting member;
wherein said second bearing assembly allows said second spinning rim to rotate independently relative to said wheel.

5. The spinning rim bicycle wheel assembly according to claim 4, wherein said first and said second spinning rims each have different moments of inertia, whereby said first and said second spinning rims are able to rotate at different speeds relative to each other.

6. The spinning rim bicycle wheel assembly according to claim 4, wherein said second spinning rim includes spinning blades having an inner portion connected to said second connecting member and an outer portion extending radially outwardly from an outer circumference of said second connecting member.

7. The spinning rim bicycle wheel assembly according to claim 2, further comprising:
a wheel mounted connecting member having a wheel mounted bearing assembly operatively connected around an inner circumference of said wheel and oppositely disposed from said wheel hub, wherein said wheel mounted bearing assembly is configured to provide independent rotational motion between said wheel mounted connecting member and said wheel;
wherein said first spinning rim is additionally connected at said outer portion to an inner circumference of said wheel mounted connecting member.

8. The spinning rim bicycle wheel assembly according to claim 1, wherein said independent rotation of said first spinning rim is selected from the group consisting of:
a) rotation of said first spinning rim in the same direction of said wheel;
b) rotation of said first spinning rim in the opposite direction of said wheel; and
c) rotation of said first spinning rim at a different rotational speed of said wheel.

9. A spinning rim assembly for mounting to a bicycle wheel, said spinning rim assembly comprising:
a connecting member having a bearing assembly for connection to a bicycle wheel hub, said bearing assembly configured to provide independent rotational motion between said connecting member and said bicycle wheel hub; and,
a spinning rim connected to and extending outwardly from said connecting member for central disposition within a bicycle wheel;
wherein said bearing assembly allows said spinning rim to rotate independently relative to the rotation of a bicycle wheel to which it may be attached.

10. The spinning rim assembly for mounting to a bicycle wheel according to claim 9, wherein said spinning rim includes spinning blades having an inner portion connected to said connecting member and an outer portion extending radially outwardly from an outer circumference of said connecting member.

11. The spinning rim assembly for mounting to a bicycle wheel according to claim 9, wherein said spinning rim is removeably connected to said connecting member.

12. The spinning rim assembly for mounting to a bicycle wheel according to claim 9, wherein said independent rotation of said first spinning rim is selected from the group consisting of:
a) rotation of said spinning rim in the same direction of said bicycle wheel;
b) rotation of said spinning rim in the opposite direction of said bicycle wheel; and
c) rotation of said spinning rim at a different rotational speed of said bicycle wheel.
